(19) United States
(12) Patent Application Publication
(10) Pub. No.: US 2003/0109369 A1
(43) Pub. Date: Jun. 12, 2003

(54) Dunnage material and process

(75) Inventors: Bernard Lerner, Aurora, OH (US); Rick S. Wehrmann, Hudson, OH (US)

Correspondence Address: WATTS, HOFFMANN, FISHER & HEINKE CO., L.P.A., P.O. Box 99839, Cleveland, OH, 44199-0839, US

(73) Assignee: Automated Packaging Systems, Inc.

(21) Appl. No.: 10/346,217

(22) Filed: Jan. 17, 2003

Related U.S. Application Data
(62) Division of application No. 09/735,345, filed on Dec. 12, 2000.

(51) Int. Cl. B31B 1/00

(52) U.S. Cl. 493/464

(57) ABSTRACT

A process of and apparatus for forming dunnage are disclosed. A chain of interconnected plastic pouches are fed along a path of travel to a fill and seal station. The pouches are sequentially opened as each pouch is positioned in the fill station. Each pouch is opened by directing a flow of air through a pouch fill opening to separate a face from a back of each such pouch and continuing the flow of air through each such opening to inflate each opened pouch. Steps are taken to control the volume of air in an inflated pouch. Each such inflated pouch is then sealed to create hermetically closed and inflated dunnage units. Novel web and dunnage units are also disclosed.

### TECHNICAL FIELD

This invention relates to dunnage and more particularly to a novel and improved web of interconnected dunnage pouches and a process of producing dunnage with such a web.

This is a continuation in part of PCT (15-060PCT) filed May 18, 2000 which in turn was a continuation in part of (15-060) filed May 20, 1999.

### BACKGROUND ART

U.S. Pat. Nos. RE36,501 and RE36,759 respectively entitled “Method for Producing Inflated Dunnage” and “Inflated Dunnage and Method for Its Production” and respectively issued Sep. 3, 1996 and Dec. 2, 1997 to Gregory A. Hoover et al. (the Dunnage Patents) disclose a method for producing dunnage utilizing preopened bags on a roll. The preopened bags utilized in the Dunnage Patents are of a type disclosed in U.S. Pat. No. 3,254,828 issued Jun. 2, 1966 to Hershey Lerner and entitled “Flexible Container Strips” (the “Autobag Patent”). The preferred bags of the Dunnage Patents are unique in that the so-called tack of outer bag surfaces is greater than the tack of inner surfaces to facilitate bag opening while producing dunnage units which stick to one another when in use.

### SUMMARY OF THE INVENTION

The present invention enhances the production of dunnage with a system which is an improvement over the process disclosed in the Dunnage Patents. Specifically, with the present invention a web in the form of a chain of interconnected pouches is provided. Each of the pouches is closed other than for a small fill opening in the form of a slit or cut out in one or both faces. Thus, the pouches contrast with bags each of which is fully open across a top portion as is the case with the Dunnage Patents and the chains of bags taught in the Autobag Patent.

The use of small fill openings obviates a problem that exists with the approach taught by the Dunnage Patents. Specifically, if either the face or back of a bag as used in the Dunnage Patents is uneven when a seal is formed, such as by wrinkling, the seal will not be fully hermetic and air will leak from the sealed bag. With the pouches of the present invention consistent hermetic seals are produced and air leakage from dunnage units is avoided.

A “multiple up” arrangement is provided for some applications such as when higher volume is desired. With the so-called multiple up arrangement, two or more side connected strips of interconnected pouches are provided. The side connections are preferably frangible to facilitate ready separation of the strips. Preferably a slit opening is provided near the top of each pouch and near the side connections in order that a single source of air can concurrently inflate two pouches, one in each strip.

In producing dunnage with the improved chain of pouches, a bagging machine of the type disclosed and claimed in U.S. Pat. Nos. 5,289,671 issued Mar. 1, 1994 and 5,394,676 issued Mar. 7, 1995 each to Bernard Lerner et al. each under the title “Packaging Machine and Method” (the “Jam Prevention” and the “Excel Patent”) is utilized. The machine is modified to provide an air nozzle which emits a flow of air during a dunnage formation portion of a cycle. The flow of air is directed at the small, preferably a slit, opening of a pouch positioned at a fill station. The air flow is from a nozzle directed at the pouch opening and in one embodiment aligned such that the axis of the flowing air intersects the web slightly above an opening of a pouch being inflated. The intersection of the axis is at an obtuse angle as measured outwardly of the machine. The flow is diverted downwardly by the web to pass through the opening of the pouch being inflated.

In the now preferred arrangement, the axis of the air flow is tangential to a face a pouch being inflated. That is, the axis of the air flow is parallel to the plane of the web. This parallel relationship is effective to cause air to flow through a preferred small slit opening in a pouch being inflated. While satisfactory results have been achieved in tests with flow at an angle of from about 0° to about 45° with the web as measured upstream from the fill opening, the zero angle flow is preferred because it creates a low pressure area adjacent the pouch causing the pouch to “pop” open and thereafter receive inflating air.

Once the flow of air has inflated a pouch, the flow is continued until shortly before a heat sealer has closed on the inflated pouch to effect a seal closing the pouch in an inflated condition to trap the inflation air in the pouch. In order to control the pressure within a pouch being sealed the machine is further modified so that a pouch being inflated is confined to limit air intake or expel air from the pouch immediately prior to seal closure. Air is limited or expelled so that pressure of the inflation air will not cause heat softened plastic adjacent the seal to rupture. The reduced pressure also provides yieldability to finished dunnage units and assures that units will not rupture at higher altitudes such as in an unpressurized cargo hold of an aircraft.

The seal is an hermetic closure formed between front and back layers of the pouch such that an hermetic closure surrounds the space. The hermetic closure consists of side folds or seals and a bottom seal formed as the chain of pouches is produced and the closure seal effected after the pouch has been inflated.

The machine modification which effects the air expulsion is the provision of coacting elements to engage the face and back of an inflated pouch at locations spaced from a location where a seal is to be formed. In the preferred arrangement the back element is fixed relative to a sealer bar. The face element is carried by a cylinder which is supported by the bagging machine. Commencing prior to the bar and pad being relatively moved toward one another to compress an inflated pouch for sealing, the elements are relatively moved toward one another into compressing, air expelling engagement with the inflated pouch to define the volume of the air within finished dunnage unit.

Dunnage units produced by the described equipment and process are usually deposited in a dunnage dispensing mechanism. The preferred dispensing mechanism is described and claimed in a concurrently filed Application by Rick Wherman under the title DUNNAGE MACHINE (attorney docket 15-614).

Accordingly, the objects of the invention are to provide a novel and improved chain of interconnected pouches, a process of producing dunnage units with those pouches and novel and improved dunnage units.

### BRIEF DESCRIPTION OF DRAWINGS

FIG. 1 is a fragmentary side elevational view of the machine of the Excel Patent modified in accordance with the present invention;

FIG. 2 is an elevational view of the machine's fill station;

FIG. 3 is a plan view of a section of one embodiment of the web of this invention;

FIGS. 4A-F are a schematic sequential showing of the dunnage formation process of the present invention;

FIG. 5 is a plan view corresponding to FIG. 3 showing the now preferred web;

FIG. 5A is a plan view of a dunnage unit formed from a pouch of FIG. 5;

FIG. 6 is a plan view corresponding to FIGS. 3 and 5 showing the double-up web of the present invention; and

FIG. 7 is an elevational view of the now preferred pouch sealing mechanism.

### DETAILED DESCRIPTION OF THE DRAWINGS

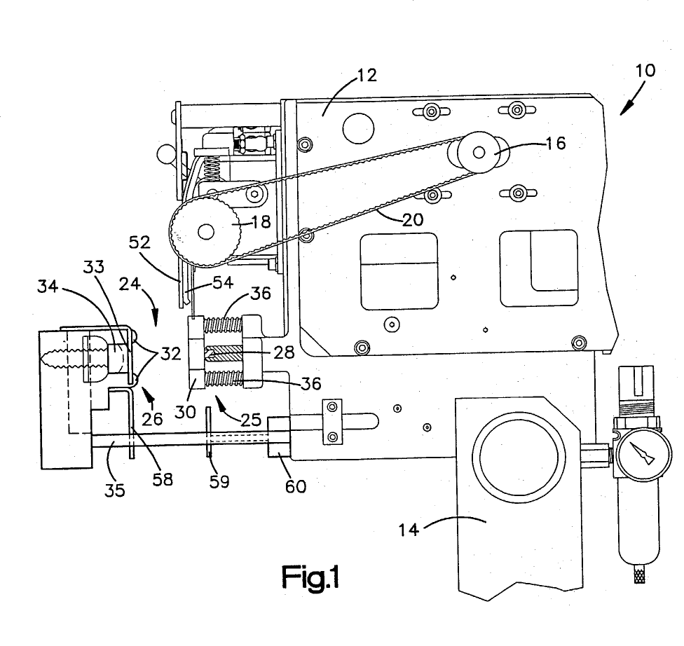

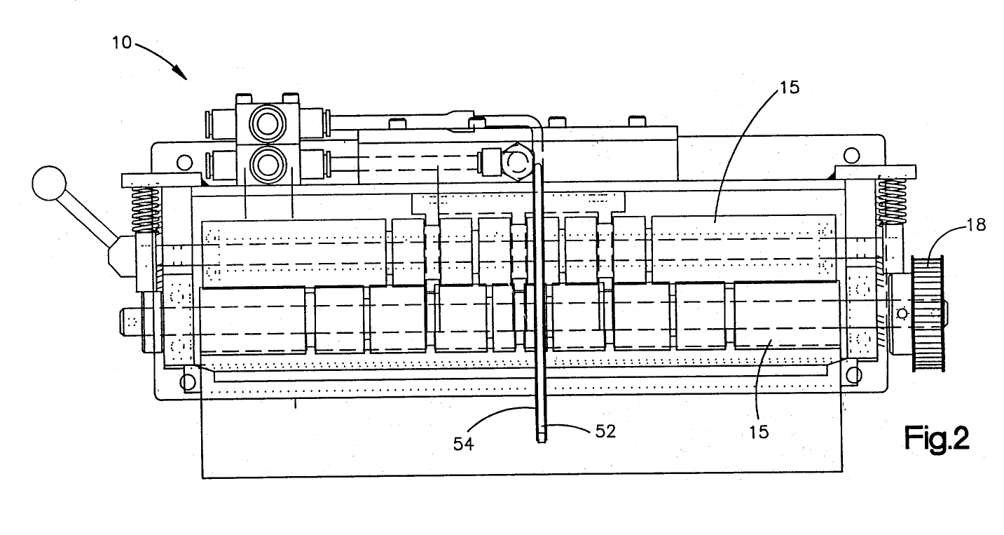

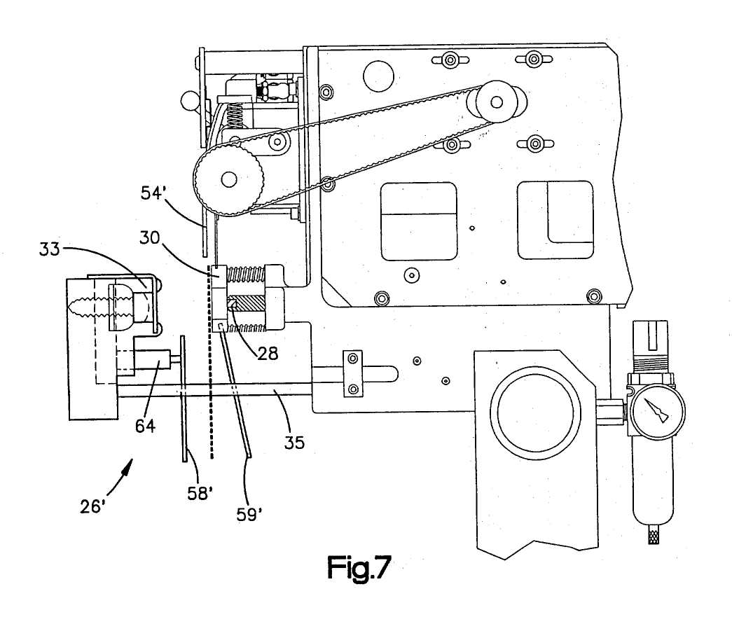

FIGS. 1 and 2 correspond respectively to FIGS. 2A and 7 of the Excel Patent modified to embody features to enable practice of the method of the present invention. The present disclosure of the machine of the Excel Patent will be limited to that portion of the machine which enables practice of the present invention. For a complete description of the entire machine of the Jam Prevention and the Excel Patents, we hereby incorporate the Jam Prevention and Excel Patents by reference.

Referring to the drawings and to FIG. 1 in particular, a fragmentary section of the machine of the Excel Patent is shown generally at 10. The machine includes a section 12 known as a bagger which is mounted on a support post 14.

The bagger 12 includes a pair of oppositely rotatable feed rolls 15, FIG. 2. Feed roll drive is accomplished through a motor not shown which is operatively connected to a drive wheel 16. The drive wheel 16 in turn drives a feed roll drive wheel 18 via a belt 20. The drive wheels are intermittently rotated to feed a web 22 through the machine and outwardly and downwardly to an inflation or fill and seal station shown generally at 24.

A web sealer is provided that includes sealer and pressure pad subassemblies 25, 26. The sealer subassembly includes a fixedly mounted heat element or sealer bar 28 and a spring biased protective plate 30. The pressure pad subassembly 26 is mounted on a pair of reciprocatable rods 35, one of which is shown in FIG. 1. The rods in turn are connected to a suitable drive such as a cylinder which, on energization, will shift the sealer pad subassembly to the right as viewed in FIG. 1 until the projections 32 clamp an inflated pouch against the protective plate 30. As travel to the right continues and prior to engagement of the projections 32 with the plate 30, a jam preventor element 33 clamps the inflated pouch against the plate 30 and the element remains stationary momentarily to cause a signal to be sent to indicate the absence of a jam as described more fully in the Jam Prevention Patent. Further travel of the rods press the protective plate against the action of springs 36 until a portion of the web 22 to be sealed is clamped between the heater bar 28 and the pressure pad 24 whereupon a seal is effected.

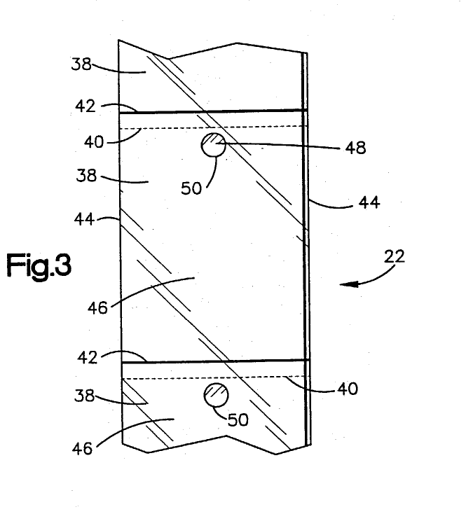

One embodiment of the web 22 is best shown in FIG. 3. The web is a flattened plastic tube which includes a series of interconnected pouches 38 with adjacent pouches being joined together by lines of weakness in the form of perforations 40. Thus, the lines of weakness delineate the ends of the interconnected pouches and facilitate the subsequent separation of the web into dunnage units.

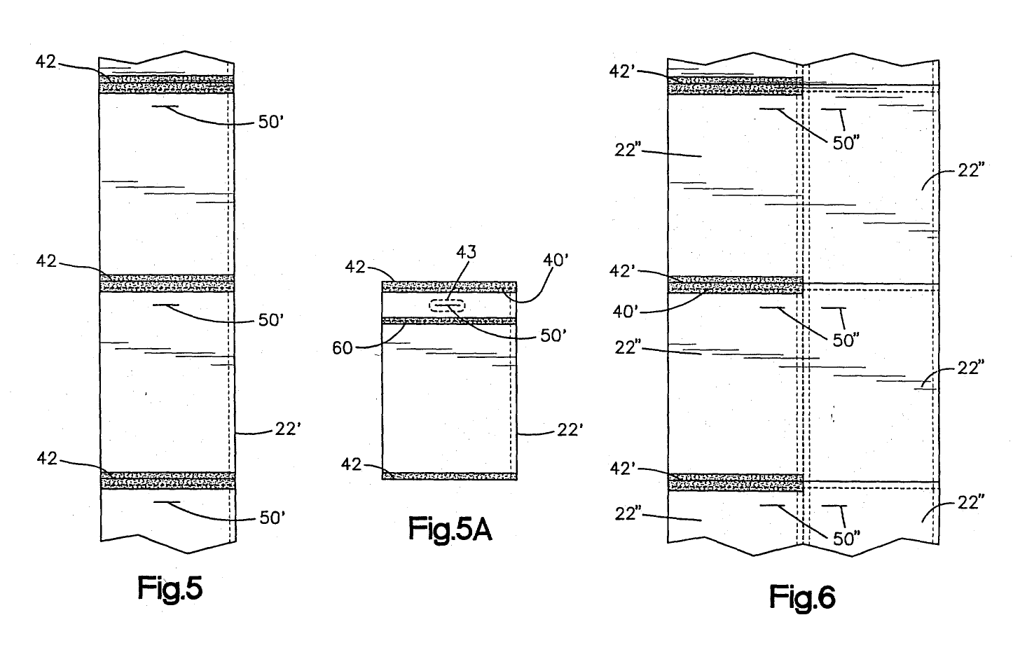

Each pouch 38 has a bottom delineated by an endless bottom seal 42. The spaced sides 44 are delineated by either folds or seals, such that a fill space for each pouch between the faces 46 and backs of 48 of the pouches is delineated by the seal 42 and the sides 44. In the embodiment of FIG. 3, each pouch face has a circular fill opening 50 formed between the sides 44 and as close as practical to the bottom seal 42 of the next pouch in the web to maximize the size of the fillable space in the pouch. In FIGS. 5 and 6 fill openings 50′ in a now preferred slit form are disclosed. When the line of weakness 40 is spaced from the bottom seal 42, each opening 50 is close to or into the line of weakness 40 delineating the top of that pouch.

Tests have shown that slit openings 50′ work very well. The slit openings provide maximized size of dunnage units from any given pouch size. The unit size is fully maximized when the line of weakness 40′ is in a bottom/top seal 42′ as shown in FIG. 5A. In this embodiment a peremitral hermetic seal surrounds the fillable space in each pouch and only a small endless seal 43 around the fill opening is required to complete a dunnage unit. Optionally, for maximized assurance of an hermetic seal a side to side seal 60 is also provided as shown in FIG. 5A.

In the of FIG. 3 and FIG. 5 embodiments, in order to avoid wrinkles and resultant leaky dunnage units, each fill opening 50 or 50′ is midway between the sides 44 and has a transverse dimension of the order of twenty-five percent of the width of the web or less. The longitudinal dimension of each circular or oval fill opening should be at least ½ the transverse dimension of the same fill opening.

The web 22 is formed of a heat sealable plastic, preferably polyethylene. While the present process can be effected with a plain polyethylene material for many applications, for packaging of heavy objects it is preferable that other surfaces have relatively high slip resistance or tack while inner surfaces of the faces and backs 46, 48 have relatively low tack to enable quick and reliable opening of each pouch as it is positioned at the fill station.

In applications where the outer surfaces have a tack greater than the inner surfaces, the outer surfaces are of sufficient tackiness to cause the dunnage units to stick together sufficiently to resist relative movement when protecting a packaged heavy object. The differences in tack between the inner and outer surfaces are achieved by forming the web from either a coextruded film or a film which has a coating of a tack different than the tack of the film which it coats.

While the currently preferred machine does not have it, the machine may have the usual intermittent air nozzle 52 which, at an appropriate time in a machine cycle, emits a puff of air to separate the face 46 from the back 48 of a pouch 38 registered at the fill station 24. Whether the intermittent nozzle 52 is present or not, a fill nozzle 54 is provided. The fill nozzle is provided for formation of dunnage units according to the present invention and as such is an addition to the machine of Excel Patent. With the circular fill openings 50 a fill nozzle with a circular outlet is preferred. Thus, with circular openings it is desirable to have complementally contoured nozzle outlets and fill openings.

Tests were conducted with a fill nozzle having a circular outlet opening ¼ inch in diameter. The fill nozzle was consistently effective in inflating pouches having circular fill openings ⅜ inch in diameter. Thus, tests have shown that a fill nozzle having an inside diameter of the order of ⅔ the diameter of the fill openings 50 produces outstanding results. In the tests, and as disclosed here, an extension of the axis of the fill nozzle 54 intersects the web slightly above and vertically aligned with the center of a fill opening of a load station positioned pouch. The intersection of the air flow with the web is at an obtuse angle as measured from the front of the machine between the axis of air flow and the plane of the web downstream from the fill opening.

Tests of the slit openings 50′ have shown that not only are they highly effective to open and direct a flow of air into pouches, but the alignment of an air nozzle with the slit opening is less critical than is alignment with a circular or oval opening 50. In such tests, 4 inch wide pouches with slit openings ¾ inch wide were used. The preferred arrangement for opening pouches with slit openings utilizes a fill nozzle 54′ as shown in FIG. 7. The nozzle 54′ preferably has an axis paralleling the face of a pouch being inflated. Thus, the nozzle 54′ is at an angle of 0 to about 45°, the zero angle is preferred.

Tests have also shown that on occasion the air within the pouch is under sufficient pressure to cause the pouch to rupture. Moreover, pouches filled with the thus far described equipment contain a volume of air under relatively high pressure such that the dunnage units are of rather firm and inflexible shape. It has been discovered that if the volume of air within the pouch is controlled to something less than maximized volume, the pressure of the volume of air within the pouch once completed is such that rupturing as a result of the sealing process is avoided. Moreover, controlled lower pressure than achieved with the system as previously described enables some amount of compression of the finished dunnage units to, for example, be stuffed between an item being packaged and the wall of the package.

One mechanism for controlling air pressure within a pouch is shown in FIG. 1 while the now preferred mechanism is shown in FIG. 7. The mechanism of FIG. 1 includes a pad plate 58 fixed to and forming a part of the pressure pad assembly 26. The pad plate 58 is positioned to engage the face of a pouch as the subassembly 26 closes to effect the seal. Concurrently, a sealer plate 59 is advanced outwardly by a cylinder 60 to engage the back of the filled pouch being sealed. Thus, the pad and sealer plates 58, 59 function to squeeze the pouch and expel some air from the filled pouch immediately before it is sealed.

In FIG. 7, a sealer plate 59′ is fixedly mounted relative to the sealer bar 28. The sealer plate 59′ slants downwardly and rearwardly. The pad plate 58′ is mounted on the machine 10 and moveable in coordination with the pressure pad subassembly 26′. More specifically, a pad plate cylinder 64 is carried by the machine 10 and connected to the pad plate 58′. The cylinder 64 is connected to the pad plate 58′ for movement toward and away from the sealer plate 59′. The plates 58′, 59′ engage an inflated pouch prior to engagement of the jam preventor element 33 and the protective plate 30 preferredly to limit the volume of air introduced into a pouch being inflated or to expel air from an inflated pouch before the sealing process commences and thereby control pressure within the unit made from that pouch.

Operation

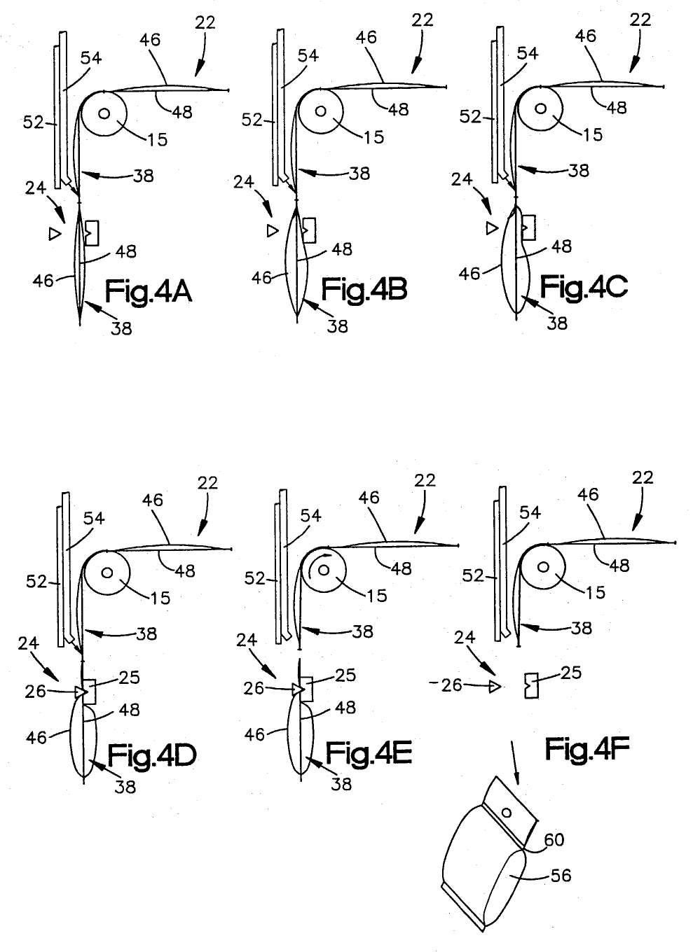

In operation, the motor which drives the drive wheel 16 is energized to advance the web 22 until one of the pouches 38 is registered at the fill station as indicated schematically in FIG. 4A. With the described web and the machine of the Excel Patent, this registration is accomplished through the use of a spark gap detector. When one of the lines of weakness 40 passes between electrodes of a spark gap detector, a spark passes between the electrodes resulting in a signal which stops the web feed. Thus, the lines of weakness function as registration indicia. Alternatively a registration system such as that described and claimed in U.S. Pat. No. 4,680,208 may be employed.

Once a pouch is located at the fill station, if the machine is equipped with an intermittent nozzle 52, a puff of air through the intermittent nozzle 52 against the fill opening 50 or 50′ separates the face 46 from the back 48 of the registered pouch, FIG. 4B. Following pouch opening, using an air supply of from 35 to 45 pounds per square inch, a continuous flow of air from fill nozzle 54 is initiated and directed through the now aligned opening 50 or 50′of the pouch. Air flow continues until the pouch reaches a fully inflated condition shown in FIG. 4C. In a preferred arrangement, a positioned pouch is both opened and filled by a flow of air from the fill nozzle 54. The flow of fill air is directed against the web at a location longitudinally aligned with the fill opening of a pouch registered in the fill and seal station. The air flows downwardly along the surface of the web and through the fill opening into the fillable space of the registered pouch.

The now preferred arrangement utilizes a slit opening 50′ and a nozzle 54′, FIG. 7, which emits a flow having an axis paralleling the face of a pouch to be inflated. Once a pouch is positioned at the fill station, air flow from the nozzle 54′ causes the pouch to “pop” open and be filled with air.

Once the registered pouch has been fully inflated, in the embodiment of FIG. 1, the pressure pad subassembly 26 is shifted to the right as viewed in the drawings. The pad plate 58 which depends below the sealer pad in fixed relationship engages the front of a pouch being sealed. Concurrently, the cylinder 60 is extended to move the sealer plate 59 into engagement with the back of the pouch being sealed. As the subassembly shifting and cylinder 60 extension continues the plates 58, 59 act to expel some air from the inflated pouch prior to sealer bar and sealer pad compression of the pouch to effect a seal. The air expulsion controls the air pressure within the pouch being sealed and prevents pouch rupture due to seal heat induced air expansion.

With the now preferred arrangement of FIG. 7, the pad cylinder 64 is energized to extend the pad plate 58′ relative to and toward the sealer plate 59′. This energization of the cylinder 64 occurs before a pouch is fed to the fill station and before the advancement of the pad subassembly 26′ commences and concludes before advancement of the subassembly is completed.

Movement of the subassembly 26 or 26′ to the right as viewed in the drawings brings the jam preventor element 33 into engagement with the face of the pouch to press it into flat juxtaposed engagement with the back of the pouch thus assisting in the production of a quality hermetic seal. As movement of the subassembly 26 or 26′ concludes, the protective plate 30 will have been shifted to the right as viewed in FIGS. 1 and 7 against the action of the springs 36 until the pouch being sealed is clamped between the pad 34 and the heater bar 28 to effect a seal between the face and the back as depicted in FIG. 4D. Once the filled pouch is clamped between the projections 32 and the protective plate 30, the pad plate 58′ is retracted and the flow of air from the fill nozzle is terminated.

As shown in FIG. 5A when the web has lines of weakness 40 spaced from the bottom seals 42, the seal being effected is a transverse seal 61 extending from side to side to complete an hermetic seal surrounding the now filled fillable space within the pouch, such that the fill opening 50 or 50′ no longer communicates with the fillable space within the pouch. In the now preferred embodiment, the lines of weakness 40′ are in the bottom/top seals 42′ as shown in FIG. 6. In that event, an endless seal 43 surrounds the fill opening 50′ to maximize unit size per unit length of the pouches, FIG. 5A. As shown in FIG. 5A, in order to maximize assurance that a pouch is hermetically sealed a redundant seal 60 is also provided.

As a pouch is being sealed, the drive wheel 16 and the rolls 15 are counter-rotated a short distance to separate the filled pouch from the web, FIG. 4E. On opening of the seal assembly, the filled pouch which is now a dunnage unit 56, is dropped from the machine as indicated in FIG. 4F. Optionally, two or more dunnage units will be formed before the separation operation, so that one can produce a chain of dunnage units of a predetermined selected length.

Each produced dunnage unit is a body formed from plastic film. The body defines an hermetically enclosed space filled with air. Optionally, the body has an outer surface which is sufficiently tacky to adhere to a body of a like dunnage unit. The body of each unit is of generally rectangular configuration. When formed from a pouch having a line of weakness spaced from a bottom seal a pair of lips project from one side of the body, the lips having been formed by one of the seals 60. With the embodiment of FIG. 3, when the seals 60, rather than 43, are used, one of the lips of each unit includes a cut out which formerly was one of the fill openings 50.

As is apparent from an examination of FIG. 6, it is fully within the scope of this invention to concurrently feed two or more webs or chains of pouches and to provide as many fill nozzles 54 as are required. With so-called “multiple up” webs that is two or more adjacent and interconnected chains of longitudinally interconnected pouches 22″, a plow 62 is preferably positioned between adjacent chains to rupture frangible interconnections between the chains as such a web is fed through the machine 10. Moreover, it is possible to provide chains of dunnage units by separating the units from the web only after chains of the desired number of units have been formed. Thus, separation occurs every other sealing operation for chains of two, every third operation for chains of three and so on.

Although the invention has been described in its preferred form with a certain degree of particularity, it is understood that the present disclosure of the preferred form has been made only by way of example and that numerous changes in the details of construction, operation and the combination and arrangement of parts may be resorted to without departing from the spirit and scope of the invention as hereinafter claimed.

What is claimed is:

1. A process of forming dunnage comprising:
a) feeding a chain of interconnected plastic pouches along a path of travel to an inflation station;
b) sequentially opening each of a plurality of pouches as each such pouch is at the inflation station by directing a flow of air through a small fill opening in a face of each pouch, each opening being in the form of a slit disposed transversely to the air flow, the air being directed at an angle of from 0° to about 45° as measured between an axis of the flow and faces of pouches upstream from the inflation station, the width of the fill opening being no more than about 25 percent of the width of the pouch, the opening step being performed as to each pouch as it is positioned in the inflation station, thereby separating the face from the back of each such pouch;
c) directing a flow of air through each such fill opening of each opened pouch to inflate each opened pouch; and
d) sealing each such inflated pouch to close each such fill opening and thereby create hermetically closed and inflated dunnage units.

2. The process of claim 1, further including separating certain of the units from the chain after said certain units are created.

3. The process of claim 1, wherein external surfaces of the plastic of the pouches have greater slip resistance than inner surfaces of the pouches.

4. The process of claim 1, wherein the longitudinal dimension of an air. outlet supplying the air flow is at least ½ the transverse dimension of the fill opening.

5. The process of claim 1, including the step of partially deflating the inflated pouch prior to the sealing step.

6. The process of claim 1, wherein the air flow is at an acute angle to the pouch being inflated as measured upstream from the opening.

7. The process of claim 1, wherein the sealing step produces endless seals respectively around the seal openings.

8. A process of creating dunnage units comprising:
a) feeding a chain of interconnected pouches along a path of travel through a machine;
b) each of the pouches having a relatively small fill opening in a pouch face and being hermetically closed at least along spaced sides and a bottom, each fill opening having a transverse dimension of the order of no more than about one fourth the width of the pouch;
c) sequentially sensing each of a series of spaced registration indicia to stop the feeding of the chain and thereby sequentially register each of the pouches at a fill station;
d) opening each such registered pouch by directing a flow of air through the fill opening of the registered pouch to separate a face and a back of the registered pouch;
e) inflating and filling each open pouch with air by directing a flow of air through the fill opening of the open pouch into a fill space; and
f) partially deflating the inflated pouch and thereafter sealing the face to the back of each inflated pouch to close off the fill opening of the inflated pouch and complete an hermetic closure around the fill space and thereby produce an inflated dunnage unit.

9. The process of claim 8, wherein the opening and fill steps are performed with air flow from the same nozzle.

10. The process of claim 8, wherein the pouch openings are slits.

11. The process of claim 8, wherein the air directing step is accomplished with a nozzle having an outlet section and an imaginary extension of an axis of the outlet section is in a common imaginary plane with the center of the fill opening of a pouch being inflated, the outlet axis being at an obtuse angle relative to the face of the pouch being inflated during the inflation step, the obtuse angle being measured in the direction of airflow and outwardly from the face of a pouch being filled in the direction of air flow.

12. For use in forming dunnage units with a packaging machine, a web comprising:
a) an elongated flattened, heat sealable, plastic tube having face and back layers interconnected along spaced side portions;
b) spaced transverse seals each extending from one side portion of the tube to the other such that each seal together with a pair of contiguous sections of the respective spaced side portions provide a continuous hermetic barrier about three sides of a fillable space between the layers;
c) spaced transverse lines of weakness formed in the layers and delineating ends of a interconnected and fillable pouches each having a face layer section, the lines of weakness serving to facilitate separation of the web into dunnage units;
d) each section delineating the face of an adjacent fillable space, each section including a small fill opening located at selected one of at and spaced from a given short distance from an associated one of the lines of weakness delineating a top of the section and a greater distance than the given distance from an associated one of the transverse seals delineating a space bottom; and
e) each fill opening having a transverse dimension of no greater than about twenty-five percent of the transverse dimension of the pouches.

13. The web of claim 12, wherein the transverse seals delineate both tops and bottoms of said fillable spaces.

14. The web of claim 12, wherein an outer surface of each layer has greater slip resistance than its inner surface.

15. The web of claim 12, wherein the fill openings are circular.

16. The web of claim 12, wherein the fill openings are slits.

17. The web of claim 12, wherein the fill openings are located generally midway between the side openings.

18. The web of claim 12, wherein there are at least two strips of pouches connected by frangible interconnections between adjacent side portions and the fill openings are near the adjacent side portions.

19. A dunnage unit comprising:
a) a body formed from plastic film defining an hermetically enclosed space filled with a quantity of air;
b) the body having an external surface having sufficient tack to enable adherence of the body to a body of a like dunnage unit;
c) the body being of generally rectangular configuration and having a pair of lips extending outwardly from one side, the lips being formed by a seal; and
d) one of the lips including a cut out which served as a fill opening when the unit was being inflated.

20. The unit of claim 19, wherein each of the lips has a plurality of small projections extending from a side edge remote from the seal and resulting from separation of the dunnage unit from a web, the separation having been of along perforated lines of weakness.

21. A process of making dunnage units comprising:
a) feeding a chain of interconnected plastic pouches along a path of travel to sequentially position the pouches at a fill station;
b) directing a flow of gas through a fill opening of each positioned pouch to inflate a positioned pouch;
c) closing a sealer and sealer pad against each such inflated pouch and expelling a portion of the inflation gas from the inflated pouch whereby to prevent the pouch form rupturing during the sealing step; and
d) sealing the pouch to form an inflated dunnage unit.

22. The process of claim 21, wherein a deflation element is connected to the sealer pad and the closing and expelling steps are accomplished by moving the pad and element toward the sealer and engaging a positioned and inflated pouch.

23. The process of claim 22 wherein a further deflation element is connected to the sealer and the bars coact to effect the expelling step.

24. The process of claim 22 wherein the feeding step is accomplished by a machine and deflation elements are carried by the machine and positioned on opposite sides of the fill station.

25. The process of claim 22 wherein a prime mover is interposed between one of the elements and a body of the machine.

26. The process of claim 25 wherein the one element is a seal bar element.

27. The process of claim 25 wherein the one element is a seal pad element.

28. A machine for forming dunnage units from elongated webs having preformed pouches connected end to end, the machine comprising:
a) structure defining a path of web travel from a supply to dunnage unit formation station;
b) a nozzle for emitting a flow of gas under pressure positioned at the station and oriented to direct a flow of gas through a fill opening in each such pouch when positioned in the station;
c) a heat sealer including sealer and seal pad members relatively moveable between spaced and sealing positions; and
d) relatively moveable pouch deflating elements moveable between spaced and deflating positions as the members are moved from their spaced to their sealing position for engaging an inflated pouch and expelling part of such gas within the inflated pouch.

29. The machine of claim 28 wherein the elements are carried by a body of the machine.

30. The machine of claim 29 wherein a prime mover is interposed between one of the elements and the body.

31. The machine of claim 30 wherein the one element is a seal pad element.

32. A process of making dunnage units comprising:
a) feeding a chain of interconnected plastic pouches along a path of travel to sequentially position the pouches at a fill station;
b) directing a flow of gas through a fill opening of each positioned pouch to inflate a positioned pouch;
c) controlling the volume of gas in each such inflated pouch to prevent the pouch from rupturing during the sealing step; and
d) sealing the pouch to form an inflated dunnage unit.

33. The process of claim 32, wherein the volume control step is effected by coaction a pair of relatively moveable pouch engaging elements.

34. The process of claim 33 wherein a prime mover is interposed between one of the elements and a body of the machine.

35. The process of claim 34 wherein the one element is a seal bar element.

36. The process of claim 35 wherein the one element is a seal pad element.

37. In a dunnage formation machine utilizing preformed pouches interconnected in a chain, an improved closure mechanism comprising:
a) a seal bar mounted at a work station;
b) a seal pad assembly movably mounted at the station;
c) the assembly including a pad prime mover for repetitively and sequentially engaging fluid filled pouches to clamp each such pouch against the seal bar to effect a seal in each such pouch;
d) a fixed plate mounted near a selected one of the bar and pad;
e) a coacting plate movably mounted near the other of the bar and pad; and
f) a plate prime mover connected to the moveable plate toward the fixed plate to squeeze a filled pouch at the station prior to the pad clamping such filled pouch whereby to control the volume of fluid in the filled pouch.

38. The closure mechanism of claim 37 wherein the selected one is the pad.

39. The closure mechanism of claim 37 wherein the selected one is the bar.

40. A process of producing dunnage comprising:
a) directing a stream of air along a surface of a face of a preformed plastic pouch to and over a slit in the surface and thereby separating a portion of the face from a back of the pouch; and,
b) thereafter continuing to flow the stream of air to inflate the pouch.

41. The process of claim 40 further including the step of sealing the pouch to maintain the inflation.

42. The process of claim 40 further including controlling the extent of inflation by engaging said surface of the face and a surface of the back.

43. The process of claim 40 wherein the stream of air is directed at an angle of from about 0° to about 45° with the face.

44. The process of claim 43 wherein the angle is about 0°.
